(19) United States
(12) Patent Application Publication
(10) Pub. No.: US 2023/0360446 A1
(43) Pub. Date: Nov. 9, 2023

(54) VEHICLE ASSISTANCE DEVICE

(71) Applicant: FORD GLOBAL TECHNOLOGIES, LLC, Dearborn, MI (US)

(72) Inventors: Clayton Benjamin FORD, Dearborn, MI (US); Ryan Wayne WARNER, Ann Arbor, MI (US); Mark VOJTISEK, Royal Oak, MI (US); Anna Frances Hardig HENDRICKSON, Southfield, MI (US)

(21) Appl. No.: 17/737,261

(22) Filed: May 5, 2022

(51) Int. Cl. G07C 5/00

(52) U.S. Cl. CPC G07C 5/008; B60W 40/13

(57) ABSTRACT

A vehicle includes a wireless transceiver configured to receive sampled data from a vehicle assistance device, the sampled data being from a plurality of sampling locations by the vehicle assistance device; and a controller programmed to generate a driving path using the plurality of sampling locations, and responsive to arriving at one of the sampling locations, adjust a vehicle setting using the sampled data corresponding to the one of the sampling locations.

### TECHNICAL FIELD

The present disclosure generally relates to a device in communication with a vehicle. More specifically, the present disclosure relates to a system for operating a vehicle in communication with a device for assisting vehicle off-roading activities.

### BACKGROUND

With the increasing popularity of sport utility vehicles (SUVs), many users are interested in exploring off-roading activities. Due to the nature of the off-road driving, sometimes the driver or passenger of the vehicle needs to get out of the vehicle to inspect the road condition ahead. For instance, the vehicle driver or passenger may examine water depths, soil conditions, ground clearances before returning to the vehicle and continuing to drive.

### SUMMARY

In one or more embodiments of the present disclosure, a vehicle includes a wireless transceiver configured to receive sampled data from a vehicle assistance device, the sampled data being from a plurality of sampling locations by the vehicle assistance device; and a controller programmed to generate a driving path using the plurality of sampling locations, and responsive to arriving at one of the sampling locations, adjust a vehicle setting using the sampled data corresponding to the one of the sampling locations.

In one or more embodiments of the present disclosure, a device includes a wireless transceiver configured to communicate with a vehicle; a location controller configured to determine a device location; a sensor configured to measure a property and generate sensor data indicative of the property; and a processor programmed to responsive to measuring a first sensor data corresponding to a first location, compare the first sensor data with a predefined threshold received from the vehicle, and responsive to the first sensor data qualifying for use according to the predefined threshold, send the first sensor data and the first location to the vehicle.

In one or more embodiments of the present disclosure, a method for a vehicle includes responsive to receiving, over a wireless connection from a vehicle assistance device, a first sampled data corresponding to a first sampling location, comparing the first sampled data with a threshold; responsive to the first sampled data qualifying the threshold, generating a driving path using the first sampling location; and responsive to arriving at the first sampling location, adjust a vehicle setting using the first sampled data.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle system of one embodiment of the present disclosure;

FIG. 2 illustrates an example diagram of the vehicle assistance device of one embodiment of the present disclosure.

FIG. 3 illustrates an example diagram of the vehicle assistance device of another embodiment of the present disclosure.

FIG. 4 illustrates an example diagram of the vehicle assistance device of yet another embodiment of the present disclosure.

FIG. 5 illustrates an example diagram of the vehicle assistance device of yet another embodiment of the present disclosure.

FIG. 6 illustrates an example diagram of the vehicle assistance device of yet another embodiment of the present disclosure.

FIG. 7 illustrates an example diagram of the vehicle assistance device of yet another embodiment of the present disclosure.

FIG. 8 illustrates and example flow diagram of a process for operating the vehicle of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices, such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a device in communication with a vehicle. More specifically, the present disclosure proposes a device in communication with a vehicle for assisting vehicle off-roading activities.

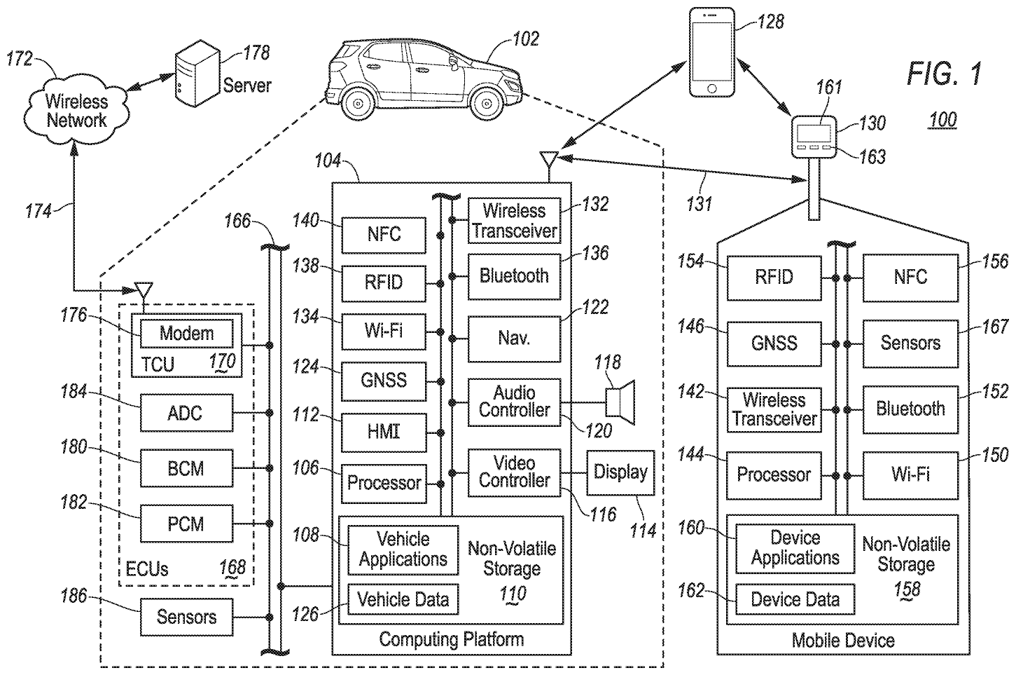

Referring to FIG. 1, an example block topology of a vehicle system 100 of one embodiment of the present disclosure is illustrated. A vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a battery electric vehicle (BEV), a hybrid electric vehicle (HEV) powered by both an internal combustion engine and one or move electric motors, such as a series hybrid electric vehicle (SHEV), a plug-in hybrid electric vehicle (PHEV), a parallel/series hybrid vehicle (PSHEV), or a fuel-cell electric vehicle (FCEV), a boat, a plane or other mobile machine for transporting people or goods. It should be noted that the illustrated system 100 is merely an example, and more, fewer, and/or differently located elements may be used.

As illustrated in FIG. 1, a computing platform 104 may include one or more processors 106 configured to perform instructions, commands, and other routines in support of the processes described herein. For instance, the computing platform 104 may be configured to execute instructions of vehicle applications 108 to provide features such as navigation, remote controls, and wireless communications. Such instructions and other data may be maintained in a non-volatile manner using a variety of types of computer-readable storage medium 110. The computer-readable storage medium 110 (also referred to as a processor-readable medium or storage) includes any non-transitory medium (e.g., tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and structured query language (SQL).

The computing platform 104 may be provided with various features allowing the vehicle occupants/users to interface with the computing platform 104. For example, the computing platform 104 may receive input from human machine interface (HMI) controls 112 configured to provide for occupant interaction with the vehicle 102. As an example, the computing platform 104 may interface with one or more buttons, switches, knobs, or other HMI controls configured to invoke functions on the computing platform 104 (e.g., steering wheel audio buttons, a push-to-talk button, instrument panel controls, etc.).

The computing platform 104 may also drive or otherwise communicate with one or more displays 114 configured to provide visual output to vehicle occupants by way of a video controller 116. In some cases, the display 114 may be a touch screen further configured to receive user touch input via the video controller 116, while in other cases the display 114 may be a display only, without touch input capabilities. The computing platform 104 may also drive or otherwise communicate with one or more speakers 118 configured to provide audio output and input to vehicle occupants by way of an audio controller 120.

The computing platform 104 may also be provided with navigation and route planning features through a navigation controller 122 configured to calculate navigation routes responsive to user input via e.g., the HMI controls 112, and output planned routes and instructions via the speaker 118 and the display 114. Location data that is needed for navigation may be collected from a global navigation satellite system (GNSS) controller 124 configured to communicate with multiple satellites and calculate the location of the vehicle 102. The GNSS controller 124 may be configured to support various current and/or future global or regional location systems such as global positioning system (GPS), Galileo, Beidou, Global Navigation Satellite System (GLONASS) and the like. Map data used for route planning may be stored in the storage 110 as a part of the vehicle data 126. Navigation software may be stored in the storage 110 as one the vehicle applications 108.

The computing platform 104 may be configured to wirelessly communicate with one or more off-board devices. For instance, the computing platform 104 may be configured to wirelessly communicate with a mobile device 128 of the vehicle users/occupants. The mobile device 128 may be any of various types of portable computing devices, such as cellular phones, tablet computers, wearable devices, smart watches, smart fobs, laptop computers, portable music players, or other device capable of communication with the computing platform 104. the computing platform 104 may be further configured to wirelessly communicate with a vehicle assistance device 130 of the vehicle users/occupants via a wireless connection 131. The computing platform 104 may be further configured to wirelessly communicate with a vehicle assistance device 130 configured to assist the vehicle in various driving conditions. A wireless transceiver 132 may be in communication with a Wi-Fi controller 134, a Bluetooth controller 136, a radio-frequency identification (RFID) controller 138, a near-field communication (NFC) controller 140, and other controllers such as a Zigbee transceiver, an IrDA transceiver, ultra-wide band (UWB) transceiver (not shown), and configured to communicate with the mobile device 128 and the vehicle assistance device 130.

The vehicle assistance device 130 may be manufactured in a variety of forms. For instance, the vehicle assistance device 130 may be in the form of a cylinder or stick having an upper end for interfacing with a user and a lower end for punching through the ground. The vehicle assistance device 130 may be further designed and manufactured as a telescopic stick for easy storage. It is noted that although the vehicle assistance device 130 is introduced in the stick shape in the description, the present disclosure is not limited thereto and the vehicle assistance device 130 may be manufactured into various shapes due to the specific design needs. The vehicle assistance device 130 may be provided with a wireless transceiver 142 configured to communicate with the wireless transceiver 132 of the computing platform 104 and a compatible transceiver (not shown) of the mobile device 128 via a variety of communication protocols. The vehicle assistance device 130 may be further provided with a processor 144 configured to perform instructions, commands, and other routines in support of the processes such as signal measurement and processing. For instance, the vehicle assistance device 130 may be provided with location functions via a GNSS controller 146. The vehicle assistance device 130 may be provided with the wireless transceiver 142 in communication with a Wi-Fi controller 150, a Bluetooth controller 152, a RFID controller 154, an NFC controller 156, and other controllers (not shown), configured to communicate with the wireless transceiver 132 of the computing platform 104 and the wireless transceiver of the mobile device 128. The vehicle assistance device 130 may be further provided with a non-volatile storage 158 to store various device application 160 and device data 162. The vehicle assistance device 130 may be further provided with HMI controls configured to interact with a user. For instance, the vehicle assistance device 130 may be provided with a display 161 configured to provide a visual output to a user. In some cases, the display 161 may be a touch screen further configured to receive user touch input, while in other cases the display 114 may be a display only, without touch input capabilities. The vehicle assistance device 130 may be further provided one or more buttons 163 to allow the user to provide input to the device.

The vehicle assistance device 130 may be provided with various sensors 167 configured to perform signal measurement of various conditions. The sensors 167 may be located at various locations of the vehicle assistance device 130. For instance, the sensors 167 may include a microphone configured to receive audio inputs to the vehicle assistance device 130. The sensors 167 may further include visual imaging sensors (e.g. camera) such as a complementary metal oxide semiconductor (CMOS) or lidar camera configured to capture images round the vehicle assistance device 130. The camera may be configured to support a 360-degree surrounding view feature enabled by a plurality of imaging sensors in one embodiment. The sensors 167 may further include environmental sensors such as a temperature sensor, an air pressure sensor, and/or an electromagnetic sensor or the like. The sensors 167 may further include inclination sensors such as an accelerometer, a liquid capacitive sensor, an electrolytic sensor, a pendulum sensor, a gyroscope or the like configured to measure a motion and inclination of the vehicle assistance device 130. The sensors 167 may further include terramechanics sensors such as a penetrometer, a shear strength sensor or the like for measuring properties of soil/terrain. In one implementation, the terramechanics sensors may be located near the lower end of the vehicle assistance device 130 to facilitate the soil property measurements when the lower end sticks into the soil.

The computing platform 104 may be further configured to communicate with various components of the vehicle 102 via one or more in-vehicle network 166. The in-vehicle network 166 may include, but is not limited to, one or more of a controller area network (CAN), an Ethernet network, and a media-oriented system transport (MOST), as some examples. Furthermore, the in-vehicle network 166, or portions of the in-vehicle network 166, may be a wireless network accomplished via Bluetooth low-energy (BLE), Wi-Fi, UWB, or the like.

The computing platform 104 may be configured to communicate with various electronic control units (ECUs) 168 of the vehicle 102 configured to perform various operations. For instance, the computing platform 104 may be configured to communicate with a telematics control unit (TCU) 170 configured to control telecommunication between vehicle 102 and a wireless network 172 through a wireless connection 174 using a modem 176. The wireless connection 174 may be in the form of various communication network e.g., a cellular network. Through the wireless network 172, the vehicle may access one or more servers 178 to access various content for various purposes. It is noted that the terms wireless network and server are used as general terms in the present disclosure and may include any computing network involving carriers, router, computers, controllers, circuitry or the like configured to store data and perform data processing functions and facilitate communication between various entities. Additionally, the computing platform 104 may communicate with the vehicle assistance device 130 via the wireless network in addition to or in lieu of the wireless connection 131. The ECUs 168 may further include a body control module (BCM) 180 configured to control body operations of the vehicle 102. For instance, the BCM 180 may be configured adjust the height and/or stiffness of the vehicle suspension and tire pressure to accommodate various driving conditions. The ECUs 168 may further include a powertrain control module (PCM) 182 configured to control a powertrain of the vehicle 102. For instance, the PCM 182 may be configured to control a power/torque output from the engine/motor, select a transmission gear, distribute torque between vehicle wheels or the like. The ECUs 168 may further include an autonomous driving controller (ADC) 184 configured to control autonomous driving features of the vehicle 102. Driving instructions may be received remotely from the server 178. The ADC 184 may be configured to perform the autonomous driving features using the driving instructions combined with navigation instructions from the navigation controller 122. The vehicle 102 may be further provided with a variety of sensors 186 configured to perform signal measurement of vehicle conditions. For instance, the sensors 186 may include one or more weight sensor configured to measure the weight/load of the vehicle 102. In case that multiple weight sensors are provided, the BCM 180 may be further configured to determine a weight distribution of the vehicle based on the data measured by the multiple weight sensors. The sensors 186 may further include a tire pressure sensor configured to measure the air pressure of one or more tires of the vehicle 102. The sensors 186 may further include a camera configured to capture images before or behand the vehicle. In some cases, the camera may be a surrounding view camera enabled by a plurality of camera lenses. The sensors 186 may further include a radar or lidar sensor configured to detect an object at a vicinity of the vehicle 102.

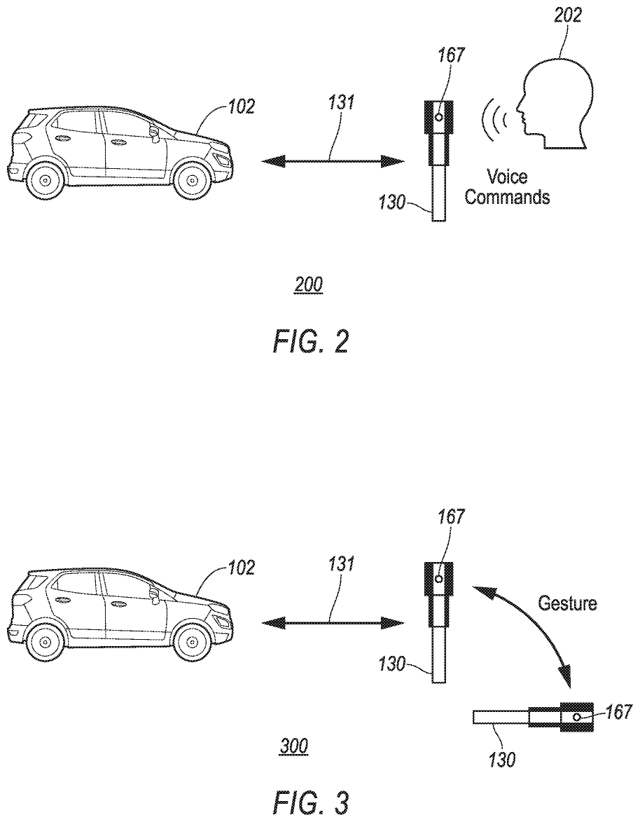

Referring to FIG. 2, an example diagram 200 illustrating a usage scenario of the vehicle assistance device 130 of one embodiment of the present disclosure is illustrated. In the present example, the vehicle assistance device 130 may be configured to perform remote control of the vehicle 102 based on voice commands from a user 202. With continuing reference to FIG. 1, the user 202 may remotely maneuver the vehicle 102 using the vehicle assistance device 130 while being outside the vehicle to make a better observation of the surroundings of the vehicle 102. This example may be applied to situations such as off-roading and/or parking. The user 202 may provide audio input such as voice commands to the microphone sensor 167 of the vehicle assistance device 130. The vehicle assistance device 130 may be configured to process the voice command received via the microphone sensor 167 and generate vehicle control commands to send to the vehicle 102 via the wireless connection 131. The vehicle control commands may operate various maneuvers of the vehicle 102. For instance, the vehicle control commands may operate the steering, speed, brakes, tire inflation of the tires of the vehicle. Responsive to receiving the vehicle control commands from the vehicle assistance device 130, the vehicle 102 may perform the corresponding maneuver using the ADC 184.

Referring to FIG. 3, an example diagram 300 illustrating a usage scenario of the vehicle assistance device 130 of another embodiment of the present disclosure is illustrated. Similar to the example as illustrated with reference to FIG. 2, the vehicle assistance device 130 may be configured to perform remote controls to the vehicle 102, except in the present example the vehicle assistance device 130 generates vehicle control commands using gesture inputs detected via a motion sensor 167 such as a gyroscope in addition to or in lieu of voice commands. The user 202 may hold one end of the vehicle assistance device 130 and perform gesture controls such as waving, tilting, rotating corresponding to one or more predefined vehicle maneuver operations. Responsive to the gesture input, the vehicle assistance device 130 may process the gesture input and generate the corresponding vehicle control commands to send to the vehicle 102.

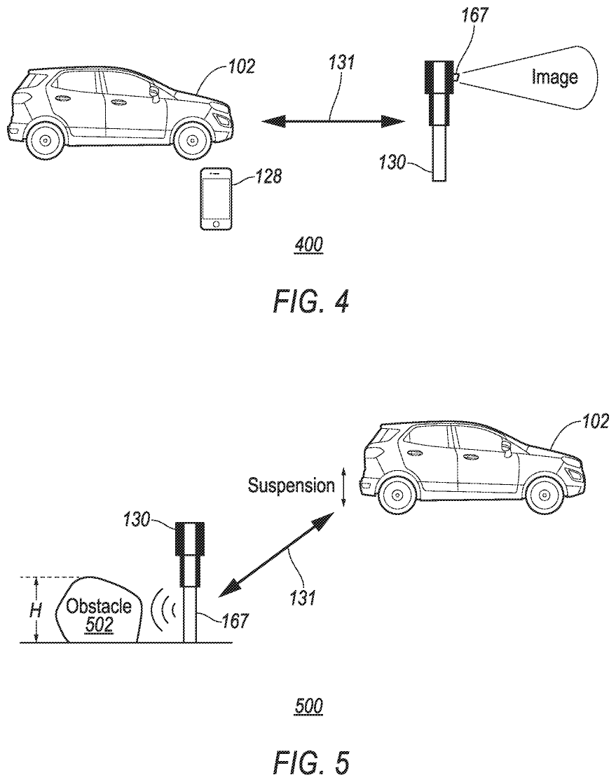

Referring to FIG. 4, an example diagram 400 illustrating a usage scenario of the vehicle assistance device 130 of yet another embodiment of the present disclosure is illustrated. With continuing reference to FIGS. 1-3, in the present example, the vehicle assistance device 130 may be used as a video/audio capturing device located outside the vehicle 102 to facilitate the driving operations. For instance, the vehicle assistance device 130 may be positioned outside the vehicle 102 to capture a video at the vicinity of the vehicle 102 via the camera sensor 167. The video may be live-streamed to the vehicle 102 via the wireless connection 131 and output via the display 114 to provide an additional visual input to the driver operating the vehicle 102. Additionally or alternatively, the vehicle assistance device 130 may be provided with a surrounding view camera enabled by a plurality of imaging sensors 167 and the processing capability to generate a surrounding view video.

The surrounding view video may be sent to the vehicle 102 and output via the display 114. Additionally or alternatively, the vehicle assistance device 130 may be further configured to communicate audio signals with the vehicle 102. The vehicle assistance device 130 may be configured to collect audio signals via the microphone sensor 167 and send the audio signals to the vehicle 102 for outputting via the speaker 118. Additionally, the vehicle assistance device 130 may be further configured to output audio voice received from a vehicle microphone (not shown) via a speaker (not shown) responsive to receiving the audio voice signal via the wireless connection 131.

Additionally or alternatively, the vehicle assistance device 130 may be further used as a waypoint device and configured to send a location information to the vehicle 102 via the wireless connection 131 to facilitate the navigation. The location information may be determined via the GNSS controller 146 of the vehicle assistance device 130.

Referring to FIG. 5, an example diagram 500 illustrating a usage scenario of the vehicle assistance device 130 of yet another embodiment of the present disclosure is illustrated. With continuing reference to FIGS. 1-4, in the present example, the vehicle assistance device 130 may be configured to measure a height of an obstacle 502 to allow the vehicle 102 to make adjustments accordingly. For instance, a vehicle user may measure the height of an obstacle 502 on a road by placing the vehicle assistance device 130 next to the obstacle 502. The vehicle assistance device 130 may be configured to measure the height of the obstacle 502 using one or more sensors 167, such as a radar sensor, lidar sensor, or a camera.

Responsive to receiving the height information from the vehicle assistance device 130 via the wireless connection 131, the vehicle 102 may adjust the vehicle settings accordingly to increase the likelihood that the vehicle 102 successfully passes the obstacle 502. For instance, the vehicle 102 may adjust the height of the suspension and/or tire pressure based on the height information as received. Additionally, the vehicle assistance device 130 may send the location of the obstacle 502 to the vehicle 102 together with the height information to allow the vehicle 102 to make the corresponding adjustment at the appropriate location. Additionally, the vehicle assistance device 130 may be further configured to capture a video of the obstacle and livestream the video to the vehicle 102 for displaying via the display 114 to provide further assistance to the driver. In another example, the obstacle may include a slope. The vehicle assistance device 130 may be configured to measure a degree of a slope via an inclination sensor 167 to facilitate the driving of the vehicle 102 under essentially the same principle.

The vehicle assistance device 130 may be configured to output instructions to ask the user to stick the lower end into the ground while keeping the vehicle assistance device 130 normal to the surface of the slope and measure the inclination of the slope using one or more inclination sensors. Responsive to receiving the inclination data, the vehicle may adjust the suspension height, differential settings or the like.

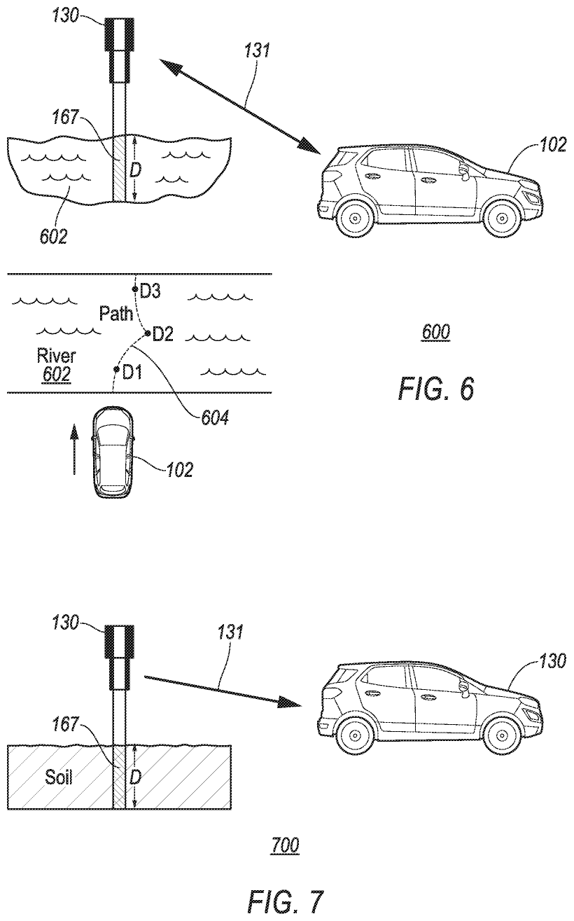

Referring to FIG. 6, an example diagram 600 illustrating a usage scenario of the vehicle assistance device 130 of yet another embodiment of the present disclosure is illustrated. With continuing reference to FIGS. 1-5, in the present example, the vehicle assistance device 130 may be configured to measure a depth of water. A vehicle user may measure the depth of water such as a water puddle or a river 602 by sticking the vehicle assistance device 130 into the bottom of the water. The vehicle assistance device 130 may be configured to measure the depth using one or more sensors 167 such as floater sensor, pressure level sensor or the like and provide the depth information to the vehicle 102 via the wireless connection 131.

The vehicle assistance device 130 may be further configured to measure the depth of the water at various locations. For instance, the user may sample the depth at multiple locations before attempting to cross the river 602. The vehicle assistance device 130 may be configured to send each of the sampled depth along with the corresponding location to the vehicle 102.

Responsive to receiving the depth information, the vehicle 102 may generate a path 604 adjust the suspension, tire pressure or the like accordingly before arriving at the sampled location on the path 604. Additionally, the computing platform 104 may be configured to generate the path 604 using the value of the sampled data. Continuing with the river-crossing example, the computing platform 104 may reject to use a sampling location for the path 604 responsive to the sampled water depth is above a predefined threshold, and send a request to the vehicle assistance device 130 to ask the user to take another sample at a different location until sufficient sampling points are received to generate the path 604.

Referring to FIG. 7, an example diagram 700 illustrating a usage scenario of the vehicle assistance device 130 of yet another embodiment of the present disclosure is illustrated. With continuing reference to FIGS. 1-6, in the present example, the vehicle assistance device 130 may be configured to measure properties of ground such as soil shear strength, moisture level, temperature, deformation or the like. This scenario may be more applicable to off-roading situations where vehicle configurations may be adjusted based on the property of the ground. The vehicle user may measure those properties by sticking the vehicle assistance device 130 into the ground. The vehicle assistance device 130 may be configured to calculate the properties of the ground by measuring raw data using one or more sensors such as a liquid capacitive sensor, a conductance sensor, a temperature sensor or the like, and transfer the property data to the vehicle. Additionally or alternatively, the vehicle assistance device 130 may be further configured to transfer the raw data to the vehicle 102 without processing the data.

Responsive to determining the ground properties, the vehicle 102 may make operation adjustments. For instance, the vehicle 102 may be configured to adjust the height of the suspension and tire pressure via the BCM 180. The vehicle 102 may be further configured to adjust the powertrain setting via the PCM 182 while traversing on the sampled ground. Additionally, the vehicle 102 may be further configured to adjust the vehicle settings based on the weight and/or weight distribution as measured by the weight sensors 186. For instance, the PCM 182 may adjust the torque distribution to different wheels and/or suspension height to different wheels based on the weight distribution.

Similar to the example discussed with reference to FIG. 6, the vehicle assistance device 130 may be further configured to only transfer the ground property data to the vehicle 102 when the property meets a predefined condition indicative of the vehicle 102 being able to pass the terrain. For instance, responsive to detecting the shear strength of the sampling location not meeting a predefined threshold as adjusted using the weight of the vehicle measured by the weight sensor 186, the vehicle assistance device 130 may ignore the current sampling location and ask the user to take another sample at a different location. Additionally or alternatively, the vehicle assistance device 130 may be further configured to send the sampled data to the vehicle 102 and mark the current location as a point to exclude for path planning purposes.

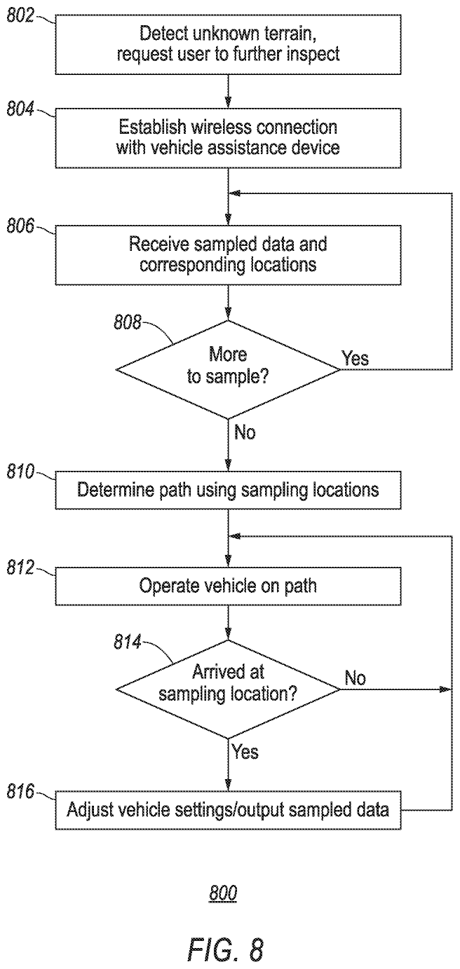

Referring to FIG. 8, an example flow diagram of a process 800 for operating the vehicle assisted by the vehicle assistance device of one embodiment of the present disclosure. With continuing reference to FIGS. 1-7, the process 800 may be implemented via the computing platform 104 individually and/or in combination with one or more controllers/ECUs 168 of the vehicle 102. For simplicity, the following description with be made with reference to the computing platform 104.

At operation 802, responsive to detecting an unknown terrain condition, the computing platform 104 outputs a request (e.g. via the HMI controls 112) to ask the user to perform further inspections to the terrain condition. The unknown terrain condition may be triggered by various factors. For instance, the computing platform 104 may detect the unknown terrain condition responsive to a wheel slipping event indicative of slippery terrain; responsive to a vehicle tilting over a predetermined amount indicative of a slope; or responsive to signal from the sensors 186 indicative of an obstacle/river or the like. The request that is output by the HMI controls 112 may further information instructing a vehicle user to turn on and operate the vehicle assistance device 130 for the further terrain inspections.

At operation 804, the vehicle 102 establishes the wireless connection 131 with the vehicle assistance device 130. Additionally, the computing platform 104 may perform one or more vehicle measurement to determine a vehicle property (e.g. the vehicle weight) and send the vehicle property to the vehicle assistance device via the wireless connection 131.

At operation 806, the computing platform 104 receives a sampled data and the corresponding location from the vehicle assistance device 130 via the wireless connection 131. The sampled data may include any information or signals transmitted from the vehicle assistance device 130 discussed above with reference to FIGS. 2-7. For instance, the sampled data may include data indicative of the property of the terrain (e.g. soil temperature, shear strength, water depth or the like) at the sampled location, video and/or audio (image, user's audio recording) collected at the sampled location, as well as remote control instructions.

At operation 808, the computing platform 104 verifies if there are more locations to be sampled by the vehicle assistance device 130. For instance, the user may make manual input to the vehicle assistance device 130 to indicate the sampling has been completed. Additionally or alternatively, the computing platform 104 may automatically determine no more samplings is available responsive to detecting the user has returned to the vehicle with the vehicle assistance device 130.

If more samplings will be performed, the process returns to operation 806. Otherwise the process proceeds to operation 810 and the computing platform 104 determines a vehicle path using the locations where the received samplings has been performed using the navigation controller 122. As discussed above, the computing platform 104 may be configured to determine the path only using the sampling points where the sampled data qualifies one or more predefined conditions (e.g. water depth, soil property or the like). The computing platform 104 may be further configured to determine and adjust the predefined conditions using the vehicle conditions such as fuel level, vehicle weight, and weight distributions. The computing platform 104 may be further configured to blacklist those sampling points where the sampled data suggests the unqualifying conditions to exclude those locations for path planning.

At operation 812, the vehicle 102 operates on the path as determined. The navigation controller 122 may output the path on the display 114 and provide driving instructions to guide the driver operating the vehicle 102 on the path. Additionally or alternatively, the ADC 184 of the vehicle 102 may autonomously operate the vehicle 102 on the path.

At operation 814, responsive to detecting the vehicle 102 has arrived at a location where one or more sampled data corresponds to, the process proceeds to operation 816 and the vehicle ECUs 168 adjust one or more vehicle settings based on the sampled data corresponding to the current vehicle location as received from the vehicle assistance device 130.

For instance, the BCM 180 may be configured to adjust the suspension height, tire pressure, drivetrain settings of the like. Additionally or alternatively, in case that the sampled data include the video/audio collected at the sampling location, the computing platform 104 may be configured to output the video/audio via the display 114 and/or the speaker 118. The video may include images reflecting road condition and surrounding environment at the sampling location to facilitate the driver. The audio may include a voice message previously recorded by the user such as “water is deep here,” “ground is slippery” to provide more information about the terrain condition.

The process returns to operation 812 to continue to operate the vehicle until the last sampling point has been reached.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle, comprising:
a wireless transceiver configured to receive sampled data from a vehicle assistance device, the sampled data being from a plurality of sampling locations by the vehicle assistance device; and
a controller programmed to
generate a driving path using the plurality of sampling locations, and
responsive to arriving at one of the sampling locations, adjust a vehicle setting using the sampled data corresponding to the one of the sampling locations.

2. The vehicle of claim 1, further includes a sensor configured to measure a vehicle weight, wherein the controller is further programmed to adjust the vehicle setting based on the weight.

3. The vehicle of claim 2, wherein the vehicle weight is indicative of a weight distribution between a plurality of wheels of the vehicle, the controller is further programmed to adjust a torque output to the plurality of wheels based on the weight distribution.

4. The vehicle of claim 2, wherein the wireless transceiver is further programmed to send the vehicle weight to the vehicle assistance device.

5. The vehicle of claim 1, wherein the controller is further programmed to responsive to receiving a first sampled data corresponding to a first sampling location, compare the first sampled data with a threshold; and
responsive to the first sampled data qualifying for use according to the threshold, use the first sampling location to generate the driving path.

6. The vehicle of claim 5, wherein the controller is further programmed to adjust the threshold using a vehicle weight measured by a sensor.

7. The vehicle of claim 1, wherein the sampled data is indicative of a soil shear strength, the controller is further programmed to adjust a tire pressure based on the soil shear strength.

8. The vehicle of claim 1, wherein the controller is further programmed to calculate a soil shear strength of soil using the sampled data indicative of raw characteristics of the soil.

9. The vehicle of claim 1, wherein the sampled data is indicative of a water depth, the controller is further programmed to adjust a suspension height based on the water depth.

10. The vehicle of claim 1, wherein the sampled data is indicative of a height of an obstacle, the controller is further programmed to adjust a suspension height based on the height of the obstacle.

11. A device, comprising:
a wireless transceiver configured to communicate with a vehicle;
a location controller configured to determine a device location;
a sensor configured to measure a property and generate sensor data indicative of the property; and
a processor programmed to
responsive to measuring a first sensor data corresponding to a first location, compare the first sensor data with a predefined threshold received from the vehicle, and
responsive to the first sensor data qualifying for use according to the predefined threshold, send the first sensor data and the first location to the vehicle.

12. The device of claim 11, wherein the processor is further programmed to:
responsive to measuring second sensor data corresponding to a second location, compare the second sensor data with the predefined threshold; and
responsive to the second sensor data insufficient short to qualify for use according to the predefined threshold, blacklist the second location.

13. The device of claim 11, wherein the sensor is further configured to receive a voice command; and the processor is further programmed to generate a driving command using the voice command.

14. The device of claim 11, wherein the sensor is further configured to detect a motion; and the processor is further programmed to generate a driving command using the motion.

15. The device of claim 11, wherein the property is indicative of at least one of a soil temperature, soil moisture level, or a soil shear strength.

16. The device of claim 11, wherein the property is indicative of a water depth.

17. The device of claim 11, wherein the first sensor data include captured video and audio.

18. A method for a vehicle, comprising:
responsive to receiving, over a wireless connection from a vehicle assistance device, a first sampled data corresponding to a first sampling location, comparing the first sampled data with a threshold;
responsive to the first sampled data qualifying the threshold, generating a driving path using the first sampling location; and
responsive to arriving at the first sampling location, adjust a vehicle setting using the first sampled data.

19. The method of claim 18, further comprising:
responsive to receiving a second sampled data corresponding to a second sampling location, comparing the second sampled data with the threshold; and
responsive to the second sampled data insufficient to qualify the threshold, exclude the second sampling location from the path.

20. The method of claim 18, further comprising: wherein the sampled data is indicative of a soil moisture level and a soil temperature, the method further comprising:
adjusting a tire pressure based on the sampled data.
